(19) United States
(12) Patent Application Publication
(10) Pub. No.: US 2008/0067399 A1
(43) Pub. Date: Mar. 20, 2008

(54) Distortion correcting apparatus for X-ray image tube

(75) Inventors: Junichi Takahashi, Yaita-shi (JP); Takayuki Kimijima, Nasushiobara-shi (JP); Kentaro Odaka, Yaita-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 11/822,634

(22) Filed: Jul. 9, 2007

Related U.S. Application Data
(63) Continuation of application No. PCT/JP2006/322384, filed on Nov. 9, 2006.

(30) Foreign Application Priority Data
Nov. 9, 2005 (JP) 2005-325187

(51) Int. Cl. H01J 1/50

(52) U.S. Cl. 250/396 ML

(57) ABSTRACT

A magnetic field intruding into an electron lens area from outside an X-ray image tube is detected by a magnetic field sensor. A magnetic field for offsetting the magnetic field is generated by a coil arranged in an input surface area of the X-ray image tube, so that the distortion is corrected by removing the effects of the magnetic field. The magnetic field sensor is arranged in an area surrounded by a magnetic shield of the X-ray image tube and constituting an outer peripheral area on the electron lens area side distant from the input surface area of the X-ray image tube. The magnetic field sensor is such that the effects of the magnetic field generated by the coil are reduced and the magnetic field intruding into the electron lens area is accurately detected.

### CROSS-REFERENCE TO RELATED APPLICATIONS

This is a Continuation Application of PCT Application No. PCT/JP2006/322384, filed Nov. 9, 2006, which was published under PCT Article 21(2) in Japanese.

This application is based upon and claims the benefit of priority from prior Japanese Patent Application No. 2005-325187, filed Nov. 9, 2005, the entire contents of which are incorporated herein by reference.

### BACKGROUND OF THE INVENTION

1. Field of the Invention

This invention relates to a distortion correcting apparatus for an X-ray image tube to correct the distortion of a visible optical image by removing effects of an external magnetic field.

2. Description of the Related Art

Generally, an X-ray image tube is used for, for example, medical X-ray diagnostic equipment and an industrial nondestructive inspection device. The X-ray image tube has a function of converting an X-ray image into an electron beam image on an input surface thereof, focusing electrons by acceleration through an electron lens, and plotting a visible optical image on an output surface thereof.

It is assumed that in the stage of focusing the electrons by acceleration through the electron lens, an external magnetic field intrudes into an area constituting the electron lens. The trajectory of the electrons, under the Lorentz force from the external magnetic field, is curved and the visible optical image is distorted. In order to prevent the external magnetic field from intruding into the electron lens area, therefore, a magnetic shield formed of a material of a high permeability is arranged around the electron lens area. The magnetic shield is hardly penetrated by X-rays, and therefore, is not formed in an X-ray path between the input surface and an X-ray source. As long as the strength of the external magnetic field intruding from the input surface of the X-ray image tube is sufficiently small as compared with terrestrial magnetism, no problem is posed. Once the external magnetic field increases beyond the terrestrial magnetism, however, the visible optical image is distorted to a sensible degree, or an image processing problem is posed by even an insensibly small change or displacement.

To cope with this situation, prior arts have been employed. According to a first prior art, the intrusion of an external magnetic field is suppressed by arranging a magnetic shield also on an input surface. According to a second prior art, a magnetic field for offsetting an external magnetic field is generated by supplying a current to a coil arranged on an input surface. According to a third prior art, data is acquired through a guide as to the degree of S-shaped distortion which may occur, and based on the data, the distortion is corrected by image processing.

With regard to the second prior art, as long as the direction of the X-ray image tube is fixed and the direction of the external magnetic field remains unchanged, one method consists in fixing the current made to flow in the coil to an optimum value. In the case of an apparatus having a mechanism presupposed to move the X-ray image tube and operated for image processing in real time or substantially in real time, however, the manual adjustment made as occasion demands could not follow the speed of the operation of the apparatus. In view of this, the two methods described below have been proposed.

In the first method of the second prior art, a sensor such as a magnetic field sensor or an angle sensor is arranged outside a tubular container of an X-ray image tube, and based on an output of the sensor following the change of motion, a current value required to offset a magnetic field is read from a table and the current is supplied to a coil accordingly (see, for example, Jpn. Pat. Appln. KOKAI Publication No. 63-121239, pp. 3-5, FIGS. 2 and 6).

In the second method of the second prior art, a coil is arranged around an input surface, and a magnetic field sensor is arranged in a space defined by the input surface and the coil. Based on an output of the magnetic field sensor, a current to be supplied to the coil is obtained from a control circuit (Jpn. Pat. Appln. KOKAI Publication No. 7-65756, pp. 3-4, FIGS. 1 and 2).

In each of these methods, a state of the X-ray image tube is detected, and a current to be supplied to the coil is determined automatically by the control circuit based on the detection data. A method combined with the third prior art is also proposed in which detection data is combined with data indicating the degree to which S-shaped distortion acquired in advance occurs in the prevailing situation, and the correction is made by image processing (Jpn. Pat. Appln. KOKAI Publication No. 2003-180666, pp. 4-6, FIGS. 1 and 2).

In the case where the magnetic shield is arranged on the input surface as in the first prior art, a dosage of the X-rays incident on the input surface is reduced, and therefore, the image deteriorates. To increase the dosage to compensate for the deterioration, on the other hand, would increase the chance of exposure. An attempt to minimize the deterioration, on the other hand, would lead to an insufficient correction effect, and therefore, the use of this method is avoided in many cases.

In the case where the sensor is arranged outside the tubular container of the X-ray image tube as in the first method of the second prior art, a relation is required to remain unchanged between the strength of the magnetic field at the place where each sensor is arranged and the strength of the magnetic field intruding into the X-ray image tube. In the case where this relation is disturbed by the presence of a magnetic material such as iron in the vicinity the place where each sensor is arranged, therefore, the problem is posed that the correction is made impossible.

The magnetic field sensor, if arranged in the space defined by the input surface and the coil as in the second method of the second prior art, on the other hand, is required to be arranged at a position not interrupting the X-rays incident on the X-ray image tube. In order to install the magnetic field sensor at a position not interrupting the X-rays in the space defined by the input surface and the coil, the magnetic field sensor is required to be arranged at a position very near to the coil. Then, even the magnetic field in the vicinity of a center axis of the X-ray image tube would be required to be offset by the magnetic field generated from the coil. For this reason, the strength of the magnetic field generated from the coil would exceed that of the external magnetic field intruding into the X-ray image tube. This poses the problem that the external magnetic field cannot be detected by the magnetic field sensor.

In the case where the correction is made by image processing based on the data as to whether the S-shaped distortion acquired in advance occurs as in the third prior art, the actual operation requires the combination with the second prior art, in which case the problem is shared with the second prior art.

### BRIEF SUMMARY OF THE INVENTION

The invention has been achieved in view of these points, and an object thereof is to provide a distortion correcting apparatus for an X-ray image tube, which is capable of correcting the distortion automatically.

According to this invention, the magnetic field sensor is arranged in the area surrounded by the magnetic shield of the X-ray image tube and not interrupting the X-rays incident on the input surface, in which the strength of the magnetic field is equal to that of the external magnetic field intruding into the electron lens area from outside the X-ray image tube. Therefore, the effects of the magnetic field generated by the magnetic field generating unit arranged on the input surface area side of the X-ray image tube are reduced. Thus, the external magnetic field intruding into the electron lens area from outside the X-ray image tube can be detected with high accuracy, while at the same time permitting the magnetic field generating unit to generate an appropriate magnetic field to offset the external magnetic field. As a result, the distortion of a visible optical image can be positively corrected by removing the effects of the external magnetic field.

Also, the magnetic field sensor is arranged in the area defined by the magnetic shield of the X-ray image tube in the outer area and containing the electron lens area side near to the input surface area of the X-ray image tube. Therefore, the effects of the magnetic field generated by the magnetic field generating unit arranged on the input surface area side of the X-ray image tube are reduced. Thus, the external magnetic field intruding into the electron lens area from outside the X-ray image tube can be detected with high accuracy, while at the same time permitting the magnetic field generating unit to generate an appropriate magnetic field to offset the external magnetic field. As a result, the distortion of the visible optical image can be positively corrected by removing the effects of the external magnetic field.

### BRIEF DESCRIPTION OF THE SEVERAL VIEWS OF THE DRAWING

FIG. 1 is a schematic diagram for explaining a section of a distortion correcting apparatus for an X-ray image tube according to a first embodiment of the invention.

FIG. 2 is a schematic diagram for explaining a section of a distortion correcting apparatus for an X-ray image tube according to a second embodiment of the invention.

### DETAILED DESCRIPTION OF THE INVENTION

The invention will be explained below with reference to embodiments thereof.

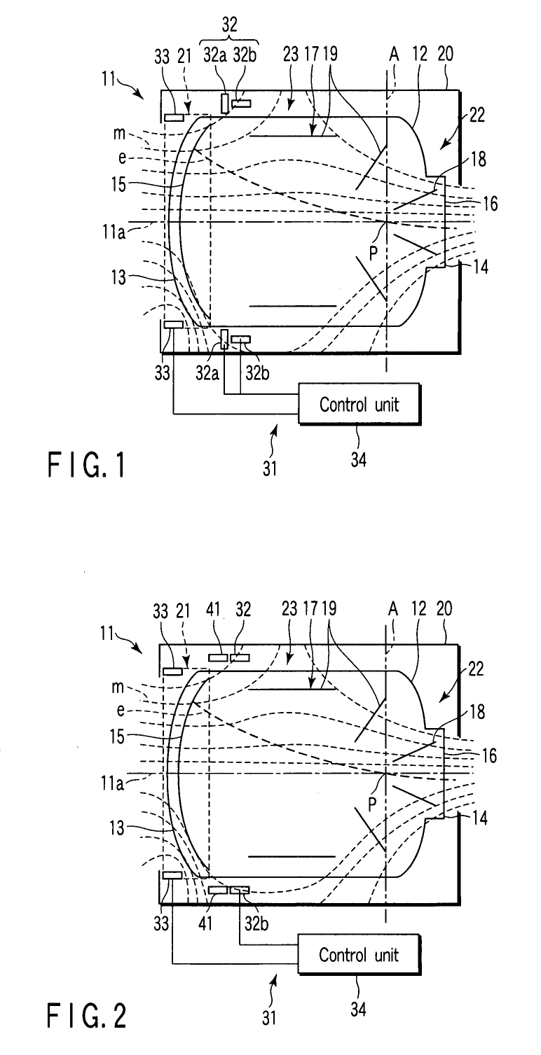

A first embodiment is shown in FIG. 1. In FIG. 1, reference number 11 designates an X-ray image tube. The X-ray image tube 11 includes a vacuum housing 12. An input window 13 is formed on an X-ray incidence side of the vacuum housing 12, and an output window 14 is formed on the side of the vacuum housing 12 far from the input window 13. In the vacuum housing 12, an input surface 15 for releasing by converting the X-rays into electrons is formed on the inside of the input window 13, and an output surface 16 for outputting by converting an electron beam into a visible optical image on the inside of the output window 14.

In the vacuum housing 12, an electron lens 17 for accelerating and focusing the electron beam is formed along an electron path from the input surface 15 toward the output surface 16. The electron lens 17 is configured by a cathode (not shown) for applying a negative voltage to the input surface 15, an anode 18 for applying a high positive voltage to the output surface 16, and a plurality of focusing electrodes 19 between the cathode and the anode 18.

The surrounding part of the vacuum housing 12 other than the input surface 15 and the output surface 16 is covered with a magnetic shield 20 configured by a material such as permalloy for shielding the effects of the magnetism.

An area of the X-ray image tube 11 where the input surface 15 is located makes up an input surface area 21, an area thereof where the output surface 16 is located makes up an output surface area 22, and an area thereof between the input surface area 21 and the output surface area 22 where the electron lens 17 is located makes up an electron lens area 23.

Next, a distortion correcting apparatus 31 of the X-ray image tube 11 includes a magnetic field sensor 32 having a magnetoelectric converter for detecting an external magnetic field m intruding into the X-ray image tube 11 from outside due to terrestrial magnetism or a magnetism generated by an external device, a coil 33 serving as a magnetic field generating unit for generating an inverse magnetic field for offsetting the external magnetic field m intruding into the X-ray image tube 11 from outside, and a control unit 34 for controlling a value of a current made to flow in the coil 33 to generate an appropriate inverse magnetic field from the coil 33.

The coil 33 is arranged between the vacuum housing 12 and the magnetic shield 20 along the peripheral portion of the input surface 15, i.e. in the input surface area 21 in such a manner as not to interrupt the X-rays incident on the input surface 15.

The magnetic field sensor 32 is arranged in an area defined by the magnetic shield 20 between the vacuum housing 12 and the magnetic shield 20, which does not interrupt the X-rays incident on the input surface 15 and which has a strength of the magnetic field equal to that of the external magnetic field m intruding into the electron lens area 23 from outside the X-ray image tube 11. In FIG. 1 showing the external magnetic field m intruding into the electron lens area 23 in the case where the area above a center axis 11a of the X-ray image tube 11 is not corrected, the strength of the magnetic field and that of the external magnetic field m intruding into the electron lens area 23 from outside the X-ray image tube are equal to each other in the outer peripheral area of the electron lens area 23. Further, the magnetic field sensor 32 is arranged on the input surface 15 side of a plane A containing a point P at which the electrons e emitted from the input surface 15 in a direction perpendicular to the center axis 11a of the X-ray image tube 11 and accelerated and focused by the electron lens 17 crosses the center axis 11a of the X-ray image tube 11. The magnetic field sensor 32, therefore, is arranged in the outer peripheral area of the electron lens area 23 on the input surface 15 side of the plane A at a position distant toward the electron lens area 23 from the input surface area 21 surrounded by the input surface 15 and the coil 33 of the X-ray image tube 11. The fact that the magnetic field sensor 32 is located on the input surface 15 side of the plane A makes it possible to positively detect the external magnetic field m intruding into the electron lens area 23.

In the magnetic shield 20 of the X-ray image tube 11, the magnetic field sensor 32 may be incapable of being arranged at a desired position due to the presence of a structure making up a product. In such a case, a plurality of magnetic field sensor 32a, 32b are arranged along the tube axis of the X-ray image tube 11 at such a position as to sandwich the desired position. Further, the plurality of magnetic field sensors 32a, 32b may be arranged along the peripheral direction of the X-ray image tube 11. The magnetic field sensors 32a, 32b, therefore, are arranged at least one each at each of a plurality of different positions along the tube axis of the X-ray image tube 11.

A direction of magnetic lines of force may change variously under the effects of both the external magnetic field m and the inverse magnetic field generated from the coil 33. For this reason, the magnetic field sensor 32 may include the plurality of magnetic field sensors 32a, 32b arranged in different directions of detection. One of the magnetic field sensors 32a, 32b, for example, is arranged in a direction of detection parallel to the center axis 11a of the X-ray image tube 11, and the other one is arranged in a direction of detection crossing the center axis 11a of the X-ray image tube 11.

The control unit 34 has a function of analyzing the effects of the external magnetic field m based on a signal output from the magnetic field sensor 32, determining a value of a current to be applied to the coil 33 required to generate the inverse magnetic field for offsetting the external magnetic field m and controlling by supplying the coil 33 with the current having the determined current value.

In the case where the plurality of magnetic field sensors 32a, 32b are employed, signals output from these magnetic field sensors 32a, 32b are combined, and based on the resulting signal, the effects of the external magnetic field m are analyzed. In the process, the output of each of the magnetic field sensors 32a, 32b may be weighted while the signal outputs thereof are combined.

Next, the operation of the distortion correcting apparatus 31 will be explained.

With reference to FIG. 1, an example of the external magnetic field m is explained in the case where the area above the center axis 1a of the X-ray image tube 11 is not corrected by the distortion correcting apparatus 31. In this case, the external magnetic field m intrudes into the electron lens area 23 from the input surface 15 of the X-ray image tube 11. At the same time, the external magnetic field m acts also on the magnetic field sensor 32 located in the outer peripheral area of the electron lens area 23 having the strength of the magnetic field equal to that of the external magnetic field m intruding into the electron lens area 23.

In the execution of the correcting process by the distortion correcting apparatus 31, the control unit 34 analyzes the effects of the external magnetic field m based on the signal output from the magnetic field sensor 32, determines a value of a current to be supplied to the coil 33 as required to generate the inverse magnetic field for offsetting the external magnetic field m and controls the current of the determined value to flow in the coil 33.

By supplying the current to the coil 33, the inverse magnetic field is generated thereby to offset the external magnetic field m.

With reference to FIG. 1, an example of the external magnetic field m in is explained in the case where the area under the center axis 11a of the X-ray image tube 11 is corrected by the distortion correcting apparatus 31. In this case, the external magnetic field m ceases to intrude into the electron lens area 23. In the stage of accelerating and focusing the electrons e by the electron lens 17, therefore, the trajectory of the electrons e is prevented from being curved by the external magnetic field m, and the distortion of the visible optical image can be positively corrected.

The magnetic field sensor 32 is arranged in the area defined by the magnetic shield 20 of the X-ray image tube 11, in which the X-rays incident on the input surface 15 are not interrupted and in which the strength of the magnetic field is equal to that of the external magnetic field m intruding into the electron lens area 23 from outside the X-ray image tube 11. Therefore, the effects of the magnetic field generated by the coil 33 arranged on the input surface area 21 side of the X-ray image tube 11 are reduced, and the external magnetic field m intruding into the electron lens area 23 from outside the X-ray image tube 11 can be accurately detected. As a result, the appropriate inverse magnetic field for offsetting the external magnetic field m can be generated by the coil 33, and the distortion of the visible optical image can be positively corrected by removing the effects of the external magnetic field m.

In the case where a single magnetic sensor 32 cannot be arranged at the desired position in the presence of the structure constituting a product, a plurality of magnetic sensors 32 may be used. Nevertheless, only one magnetic sensor 32 may be used in the case where it can be located at the desired position.

Also, in the case where a sufficient detection sensitivity cannot be secured by a single magnetic field sensor 32, a plurality of magnetic field sensors 32 may be arranged in the same direction of detection to produce a sufficient detection sensitivity.

A second embodiment is shown in FIG. 2. In FIG. 2, the component parts having the same functions as those in FIG. 1 are designated by the same reference numbers, respectively, and not described in detail. FIG. 2 shows an example of the external magnetic field m in the case where the area above the center axis 11a of the X-ray image tube 11 is not corrected by the distortion correcting apparatus 31, while the area under the center axis 11a of the X-ray image tube 11 is corrected by the distortion correcting apparatus 31.

A magnetic circuit 41 is arranged in the vicinity of the magnetic field sensor 32 thereby to lead the external magnetic field m to the magnetic field sensor 32.

The magnetic circuit 41 is intended to change the direction of the magnetic field, and therefore, may have the permeability other than a value for vacuum or preferably at least 10.

The second embodiment of the invention has similar effects to the first embodiment described above.

According to this invention, the effects of the magnetic field generated by the magnetic field generating unit arranged on the input surface area side of the X-ray image tube are reduced. Thus, the external magnetic field intruding into the electron lens area from outside the X-ray image tube can be accurately detected, and the appropriate magnetic field for offsetting the external magnetic field can be generated by the magnetic field generating unit, while at the same time positively correcting the distortion of the visible optical image by removing the effects of the external magnetic field.

What is claimed is:

1. A distortion correcting apparatus for an X-ray image tube including a vacuum housing having an input surface, an electron lens and an output surface, the vacuum housing being covered with a magnetic shield, comprising:
a magnetic field sensor which detect a magnetic field intruding into an electron lens area from outside the X-ray image tube, the magnetic field sensor being arranged in an area which is defined by the magnetic shield of the X-ray image tube and does not interrupt X-rays incident on the input surface and which has a strength of the magnetic field equal to that of an external magnetic field intruding into the electron lens area from outside the X-ray image tube;
a magnetic field generating unit arranged on the input surface area side of the X-ray image tube, the magnetic field generating unit generating a magnetic field for offsetting the external magnetic field intruding into the electron lens area from outside the X-ray image tube; and
a control unit which causes the magnetic field generating unit to generate a magnetic field for offsetting the external magnetic field based on the detection of the external magnetic field by the magnetic field sensor.

2. The distortion correcting apparatus for an X-ray image tube according to claim 1, wherein
the magnetic sensor is arranged on the input surface side of a plane perpendicular to a center axis of the X-ray image tube and containing a point where electrons emitted from the input surface and accelerated and focused by the electron lens crosses the center axis of the X-ray image tube.

3. The distortion correcting apparatus for an X-ray image tube according to claim 1, wherein
a plurality of magnetic sensors, each of which has the same configuration as the magnetic sensor, are arranged, and
the control unit causes the magnetic field generating unit to generate a magnetic field for offsetting the external magnetic field based on the external magnetic field intruding into the electron lens area obtained by combining signals detected from said plurality of magnetic field sensors.

4. The distortion correcting apparatus for an X-ray image tube according to claim 3, wherein
at least one magnetic field sensor is arranged at each of a plurality of different positions in a direction along a tube axis of the X-ray image tube.

5. The distortion correcting apparatus for an X-ray image tube according to claim 3, wherein
said plurality of magnetic sensors each have a direction of detection of the external magnetic field, and are arranged in the same direction of detection.

6. The distortion correcting apparatus for an X-ray image tube according to claim 3, wherein
said plurality of magnetic sensors each have a direction of detection of the external magnetic field, and are arranged in different directions of detection.

7. The distortion correcting apparatus for an X-ray image tube according to claim 1, wherein
the magnetic sensor has a direction of detection of the external magnetic field and is arranged in the direction of detection coincident with the direction of the external magnetic field.

8. The distortion correcting apparatus for an X-ray image tube according to claim 1, wherein
the magnetic sensor has a direction of detection of the external magnetic field,
the apparatus comprising a magnetic circuit which leads the external magnetic field to be directed in accordance with the direction of detection of the magnetic field sensor.

9. A distortion correcting apparatus for an X-ray image tube including a vacuum housing having an input surface, an electron lens and an output surface, the vacuum housing being covered with a magnetic shield, comprising:
a magnetic field sensor which detects an external magnetic field intruding into an electron lens area from outside the X-ray image tube, the magnetic field sensor being arranged in an area which is surrounded by the magnetic shield of the X-ray image tube outside the input surface area of the X-ray image tube containing the electron lens area;
a magnetic field generating unit arranged on the input surface area side of the X-ray image tube, the magnetic field generating unit generating a magnetic field for offsetting the external magnetic field intruding into the electron lens area from outside the X-ray image tube; and
a control unit which causes the magnetic field generating unit to generate a magnetic field for offsetting the external magnetic field based on the detection of the external magnetic field by the magnetic field sensor.

10. The distortion correcting apparatus for an X-ray image tube according to claim 9, wherein
the magnetic sensor is arranged on the input surface side of a plane perpendicular to a center axis of the X-ray image tube and containing a point where electrons emitted from the input surface and accelerated and focused by the electron lens crosses the center axis of the X-ray image tube.

11. The distortion correcting apparatus for an X-ray image tube according to claim 9, wherein
a plurality of magnetic sensors, each of which has the same configuration as the magnetic sensor, are arranged, and
the control unit causes the magnetic field generating unit to generate a magnetic field for offsetting the external magnetic field based on the external magnetic field intruding into the electron lens area obtained by combining signals detected from said plurality of magnetic field sensors.

12. The distortion correcting apparatus for an X-ray image tube according to claim 11, wherein
at least one magnetic field sensor is arranged at each of a plurality of different positions in a direction along a tube axis of the X-ray image tube.

13. The distortion correcting apparatus for an X-ray image tube according to claim 11, wherein
said plurality of magnetic sensors each have a direction of detection of the external magnetic field, and are arranged in the same direction of detection.

14. The distortion correcting apparatus for an X-ray image tube according to claim 11, wherein
said plurality of magnetic sensors each have a direction of detection of the external magnetic field, and are arranged in different directions of detection.

15. The distortion correcting apparatus for an X-ray image tube according to claim 9, wherein
the magnetic sensor has a direction of detection of the external magnetic field and is arranged in the direction of detection coincident with the direction of the external magnetic field.

16. The distortion correcting apparatus for an X-ray image tube according to claim 9, wherein
the magnetic sensor has a direction of detection of the external magnetic field,
the apparatus comprising a magnetic circuit which leads the external magnetic field to be directed in accordance with the direction of detection of the magnetic field sensor.
